(19) United States
(12) Patent Application Publication
(10) Pub. No.: US 2025/0216855 A1
(43) Pub. Date: Jul. 3, 2025

(54) DYNAMIC MAP REGENERATION BASED ON SELF-LEARNING COOPERATION-BASED FEEDBACK

(71) Applicant: Intel Corporation, Santa Clara, CA (US)

(72) Inventors: Efraim VITZRABIN, Kiryat Uno (IL); Dan HOROVITZ, Rishon Lezion (IL); Igal GUREVICH, Moshav Emunim (IL)

(21) Appl. No.: 18/889,386

(22) Filed: Sep. 19, 2024

Related U.S. Application Data
(60) Provisional application No. 63/615,808, filed on Dec. 29, 2023.

(51) Int. Cl. G05D 1/246; G05D 111/10

(52) U.S. Cl. CPC G05D 1/2464; G05D 2111/17

(57) ABSTRACT

Disclosed herein are devices, methods, and systems for map regeneration of an environment. The system includes a map manager configured to maintain a global map of the environment. The system also includes a robot configured to determine a correspondence between a mapped subarea of the environment and a global map of the environment and, based on the correspondence, transmit map data of the mapped subarea to a map manager. The map manager is configured to determine a quality metric of the map data of the mapped subarea with respect to the global map and update the global map with the map data of the mapped subarea based on the quality metric.

### CROSS-REFERENCE TO RELATED APPLICATION(S)

This application claims priority to U.S. Provisional Application No. 63/615,808 filed on Dec. 29, 2023, the contents of which is fully incorporated herein by reference.

### TECHNICAL FIELD

This disclosure relates generally to robots, and in particular to autonomous mobile robots (AMRs) that may use simultaneous localization and mapping (SLAM) techniques when autonomously exploring and moving about an environment.

### BACKGROUND

In order to safely move from one location to another location within an environment, a robot such as an autonomous mobile robot (AMR) typically requires an accurate map of the environment and an accurate indication of the AMR's current position with respect to the map. When the environment is unknown or constantly changing, the AMR might need an updated map before it is able to safety move through the environment. When AMR is moving, it must simultaneously keep track of its position and align its position with the map. This two-part process of mapping and localization may be referred to as simultaneous localization and mapping (“SLAM”). Typically, an AMR may switch between operate in a mapping mode (e.g., where the AMR is collecting map information for updating the map) or in a navigation/localization mode (e.g., where the AMR is moving within the environment and updating its position on the map of the environment). Typically, these modes are independent, and the AMR does not simultaneously update the map and localize itself on the map at the same time.

For example, in a mapping mode, the AMR may use a light detection and ranging (“LiDAR”) sensor to measure distances to obstacles from the AMR, which distances may be translated onto a map of the area around the AMR. In a navigation mode, motion sensors may be used to estimate the AMR's relative position on the map as it moves throughout the environment. However, sensors and the SLAM-based algorithms used to map the environment and/or correlate the AMR's position to the map are not always accurate, and in a constantly changing environment, the AMR's current map may not be sufficiently accurate for localization. If the AMR's position cannot be ascertained, then the AMR is also unable to provide useful map information for updating the map or the map data may become corrupted with incorrect object data and/or an incorrect position relative to the AMR.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of an improved navigation and localization system for an autonomous robot; and

FIG. 2 depicts a schematic flow diagram of an exemplary method for improved mapping and localization system.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™M, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

A “robot” may be understood to include any type of machine. By way of example, a robot may be a movable or stationary machine, which may have the ability to move relative to itself (e.g., movable arms, joints, tools, etc.) and/or to move relative to its environment (e.g., move from one location in an environment to another location of the environment). A robot should be understood to encompass any type of vehicle, such as an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, or a rocket, among others. Thus, references herein to “robot” or autonomous mobile robot (AMR) should be understood to broadly encompass all of the above.

The term “autonomous” may be used in connection with the term “robot” or “mobile robot” (e.g., and AMR) to describe a robot that may operate, at least to some extent, without human intervention, control, and/or supervision. For example, an autonomous robot may make some or all navigation, movement, and/or repositioning decisions without human intervention. The term “autonomous” does not necessarily imply, however, that sensors, data, or other processing must be internal to (e.g., on-board) the robot, but rather, an autonomous robot may utilize internal systems or distributed systems, where at least part of the sensor information, processing, and other data may be received by the robot from external (e.g., off-board) sources, communicated from devices external to the robot (e.g., transmitted wirelessly from a device that is external to the robot).

As noted above, during map regeneration or after a map of the environment has been generated, the environment may experience changes that impact the current map. For example, the layout of a factor floor may change (e.g., a human reorganizes an area), objects may enter the environment (e.g., additional inventory may be added to environment), objects may be removed from the environment (e.g., inventory may be moved away or consumed), the size of the warehouse with more/less storage space may change, the warehouse may be reorganized and various stations may be relocated, a new automation system may change the outlay of the warehouse, product with various sizes and weights may be repositioned to increase efficiency and support demand needs, etc. As a result of such changes, a robot that may be using an out-of-date map that does not reflect the current environment may not be able to localize itself in the environment because the map it is using does not reflect the actual environment. As a result, the robot's localization output may be inaccurate such that it fails to align its coordinates to the real world, this may cause harm to others in the environment. The robot may switch to a mapping mode in order to scan the environment and update its map. However, if its initial position on the map was incorrect, the mapping may end up incorrectly mapping the area and thereby destroying the usefulness of the map altogether.

To overcome these inaccuracies, the robot may use an improved mapping and localization system, where the robot assesses the environment to determine whether it recognizes the environment and until it matches an area in the environment to its current map (e.g., until it reaches an area it already knows), then it may begin mapping the environment from this known area. A map manager may be used to collect map information from numerous robots, assess an accuracy/quality/confidence level of the map information received from the robots, and then update the current map based on the accuracy, quality, and/or confidence level of the received map information. This allows the map manager to update a collective map from different views, from many different locations, and from the many robots within the environment. If the received map information is inaccurate, then map manager may decline to update the map with the received information, preserving the quality and accuracy of the global map. Once the map is updated, the map manager may transmit the new global map to the robots for localization and navigation within the environment. The process may then repeat as the robots continuously monitor the environment for changes, reporting any new map information to the map manager for assessment as to whether to update the global map accordingly.

This improved mapping and localization system may be advantageous in that there may be not single point of failure because the system. For example, if there is a problem with the sensor of a specific robot, or if the localization algorithm failed to accurately determine the robot's position in the environment, rather than remapping with this information, the remapping may wait until more accurate information arrives, thereby avoiding corruption of the map that may be used globally by other robots. Because the mapping information may be collected from multiple robots, the mapping may be from several different directions and the changed areas may be updated while retaining the unchanged areas of the map. The map manager may also use information from fixed sensors (e.g., cameras that are mounted within the environment).

Unlike conventional, collaborative SLAM, the disclosed mapping and localization system does not necessarily require multiple robots to gather map data (though, as should be appreciated, it may be advantageous to have multiple AMRs that are reporting map data to the map manager). Rather, a single robot may provide the data, the accuracy of which may be evaluated by the map manager and compared against other sources of map data (e.g., fixed sensors or other environmental information). Because the map manager is validating the accuracy of received map information before updating the map, the current global map may be more accurate, may remain more accurate, and may include information stitched together from several directions (e.g., containing different points of view (POV)). In addition, the disclosed mapping and localization may be done in real-time while the robot is carrying out its normal tasks and does not require a specially-tasked robot to map the environment. Thus, the disclosed mapping and localization system may improve productivity.

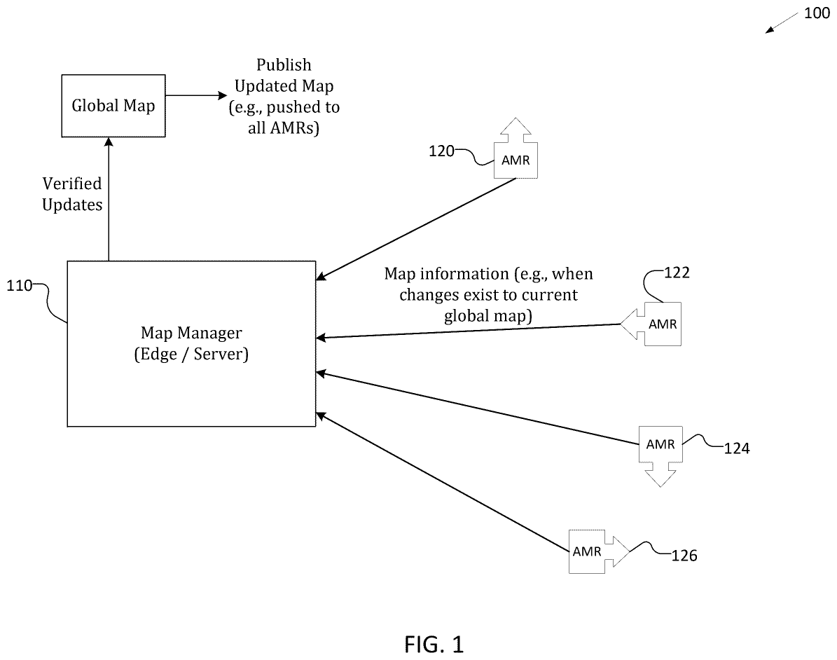

FIG. 1 shows a mapping and localization system 100 may utilize a map manager 110 (e.g., on an edge-based or cloud-based server) to collect and evaluate map information from a number of AMRs (e.g., AMR 120, 122, 124, 126) that may be operating in the environment and that may have the capability of sensing information about the environment (e.g., having onboard cameras, depth cameras, light ranging and detection (LiDAR) sensors/systems, etc.). As should be understood, while only four AMRs are shown, any number of AMRs may be operating in the environment and may provide mapping information to map manager 110.

When an AMR (e.g., AMR 120, 122, 124, or 126) moves to a position within the environment (e.g., an area/location in a warehouse) at which it is unable to localize itself on its current map (e.g., it does not find a match on the global map it has), the AMR may begin mapping this area (e.g. as a background task). As should be understood, the AMR may utilize conventional object recognition algorithms to eliminate purely dynamic objects from the map, such as humans or other robots that would not make up a part of the map of the environment. The AMR may continue mapping the area until it is able to match an area to the current (e.g., a priori) global map of the environment. The AMR may then send the collected map information (e.g., the submap of an area of the environment that was mapped by the AMR) (e.g., a mapped subarea) to the map manager 110 (e.g., on an edge-based or cloud-based server). The map manager 110 may collected such map information from any number of AMRs (e.g., AMR 120, 122, 124, and/or 126), where the AMRs may have different entry points to the environment, and each AMR may be operating in a different subarea of the overall environment for which there is a global map.

Before the global map is updated with information from the submaps that are transmitted to the map manager 110, the map manager 110 may first verify/qualify the received map information. Before the received submaps are joined/assimilated into the global map, the map manager 110 may verify the submap using a set of rules. For example, the map manager 110 may assess the quality of the submap data by comparing it to other submaps, and (e.g., only) if the maps are the same (e.g., sufficiently similar in terms of occupancy information, categorization, etc.) should the submap data be used to update the global map. For example, the map manager 110 may use a threshold-based algorithm defined based on environmental characteristics (e.g., floor reflection, light conditions, etc.) and map accuracy predefined values. If the submap has descriptors at the same locations that match another part of the map (e.g., it may be successfully “stitched’ together with the global map and/or to another submap (e.g., along one of its edges)), the map manager 110 may deep the submap accurate enough to be incorporated into global map such that the global map is updated with the verified submap. After updating the global map, the map manager 110 may transmit the updated global map to all of the AMRs (e.g., AMR 120, 122, 124, 126) in the environment so that each AMR may use the updated map for localization and navigation. The map manager 110 may also transmit the updated map to other nodes that may utilize the map (e.g., AMRs outside of the environment, inspectors, warehouse workers, inventory counters, warehouse controllers, or other algorithms that rely on an accurate map of the environment). Then, this process may continue. As the AMRs detect changes to/deviations from the current global map, they may collect and send map information to the map manager 110 for verification and inclusion in an updated global map as appropriate.

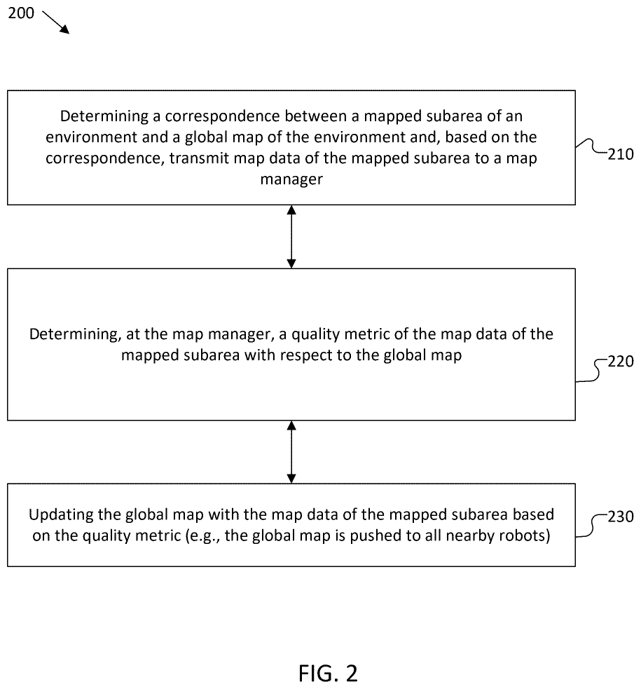

FIG. 2 shows an example flow diagram of a method 200 for an improved system for map regeneration of an environment. Method 200 may implement any of the features of the mapping and localization systems discussed above.

Method 200 includes, in 210, determining a correspondence between a mapped subarea of an environment and a global map of the environment and, based on the correspondence, transmit map data of the mapped subarea to a map manager. Method 200 also includes, in 220, determining, at the map manager, a quality metric of the map data of the mapped subarea with respect to the global map. Method 200 also includes, in 230, updating the global map with the map data of the mapped subarea based on the quality metric.

In the following, various examples are provided that may include one or more aspects described with reference to the mapping and localization systems discussed above and/or any of FIGS. 1-2. The examples provided in relation to the devices may apply also to the described method(s), and vice versa.

Example 1 is a device including a processor configured to determine a correspondence between a global map of an environment and a mapped subarea of the environment, wherein the mapped subarea is received from a robot within the environment. The processor is also configured to determine a quality metric of map data of the mapped subarea with respect to the global map. The processor is also configured to update the global map with the map data of the mapped subarea based on the quality metric.

Example 2 is the device of example 1, wherein the processor is configured to determine the quality metric based on a comparison of the map data of the mapped subarea to an second set of map data that at least partially overlaps with the mapped subarea, wherein the second set of map data is received from a second robot in the environment.

Example 3 is the device of example 2, wherein the processor is configured to update, based on whether the map data of the mapped subarea satisfies a predefined criterion with respect to the second set of map data, the global map with the map data of the mapped subarea.

Example 4 is the device of example 3, wherein the predefined criterion includes an occupancy metric that characterizes occupied spaces in the mapped subarea and relates to occupancy information of the map data and of the second set of map data that at least partially overlaps with the mapped subarea.

Example 5 is the device of example 3, wherein the predefined criterion includes an environmental characteristic of the map data with respect to the second set of map data.

Example 6 is the device of example 5, wherein the environmental characteristic includes a floor reflection or a light condition of the mapped subarea.

Example 7 is the device of example 3, wherein the predefined criterion includes an extent to which objects in the global map correspond to objects within the map data of the mapped subarea.

Example 8 is the device of example 1, wherein the processor configured to update the global map includes the processor configured to stitch together the map data of the mapped subarea with the global map.

Example 9 is the device of example 8, wherein the processor is further configured to stitch together the map data along an edge of the mapped subarea with an edge of the global map.

Example 10 is the device of example 1, wherein the processor configured to maintain the global map includes the processor configured to store the global map in a memory.

Example 11 is the device of example 1, wherein the processor configured to determine the correspondence includes the processor configured to identify occupied space in the map data of the mapped subarea that differs from the global map.

Example 12 is the device of example 1, wherein the processor configured to determine the correspondence includes the processor configured to determine whether the mapped subarea is contained within the global map.

Example 13 is the device of example 1, the device further including a sensor configured to collect the map data of the mapped subarea and to provide the map data to the processor.

Example 14 is the device of example 13, wherein the sensor includes a camera, a depth camera, an infrared camera, a light detection and ranging (LiDAR) sensor.

Example 15 is the device of example 1, wherein the quality metric is based on a comparison of the map data of the mapped subarea to an second set of map data that at least partially overlaps with the mapped subarea, wherein the processor is configured to receive the second set of map data from a fixed sensor within the environment.

Example 16 is the device of example 15, wherein the fixed sensor includes a stationary camera, depth camera, infrared camera, or light detection and ranging (LiDAR) sensor.

Example 17 is the device of example 1, wherein the processor configured to determine the correspondence includes the processor configured to determine whether the robot is able to localize itself on the global map.

Example 18 is the device of example 1, wherein the quality metric includes a confidence metric for the map data of the mapped subarea.

Example 19 is the device of example 1, wherein the robot is configured to update the global map in real-time when the map data of the mapped subarea is received from the robot.

Example 20 is the device of example 1, wherein the processor is configured to transmit the global map as an updated global map to the robot.

Example 21 is the device of example 1, wherein the processor is further configured to control the robot to use the updated global map for navigation.

Example 22 is a system for map regeneration of an environment, the system including a map manager configured to maintain a global map of the environment. The system also includes a robot configured to determine a correspondence between a mapped subarea of the environment and a global map of the environment and, based on the correspondence, transmit map data of the mapped subarea to a map manager, wherein the map manager is configured to determine a quality metric of the map data of the mapped subarea with respect to the global map. The map manager is also configured to update the global map with the map data of the mapped subarea based on the quality metric.

Example 23 is the system of example 22, wherein the quality metric is based on a comparison of the map data to a second set of map data that at least partially overlaps with the mapped subarea received from a second robot in the environment.

Example 24 is the system of example 23, wherein the map manager is configured to update, based on whether the map data of the mapped subarea satisfies a predefined criterion with respect to the second set of map data, the global map with the map data of the mapped subarea.

Example 25 is the system of example 24, wherein the predefined criterion includes an occupancy metric that characterizes occupied spaces in the mapped subarea and relates to occupancy information of the map data and of the second set of map data that at least partially overlaps with the mapped subarea.

Example 26 is the system of example 24, wherein the predefined criterion includes an environmental characteristic of the map data with respect to the second set of map data.

Example 27 is the system of example 26, wherein the environmental characteristic includes a floor reflection or a light condition of the mapped subarea.

Example 28 is the system of example 24, wherein the map manager configured to stitch together the map data along an edge of the mapped subarea with an edge of the global map.

Example 29 is the system of example 24, wherein the predefined criterion includes an extent to which objects in the global map correspond to objects within the map data of the mapped subarea.

Example 30 is the system of example 22, wherein the map manager configured to update the global map includes the map manager configured to stitch together the map data of the mapped subarea with the global map.

Example 31 is the system of example 22, wherein the map manager configured to maintain the global map includes the map manager configured to store the global map in a memory.

Example 32 is the system of example 22, wherein the robot configured to determine the correspondence includes the robot configured to identify whether occupied space in the map data of the mapped subarea differs from the global map.

Example 33 is the system of example 22, wherein the robot configured to determine the correspondence includes the robot configured to determine whether the mapped subarea is contained within the global map.

Example 34 is the system of example 22, wherein the robot further includes a sensor configured to collect map data of the mapped subarea.

Example 35 is the system of example 34, wherein the sensor includes a camera, a depth camera, an infrared camera, a light detection and ranging (LiDAR) sensor.

Example 36 is the system of example 22, wherein the quality metric is based on a comparison of the map data to a second set of map data that at least partially overlaps with the mapped subarea, wherein the map manager is configured to collect the second set of map data from a fixed sensor within the environment.

Example 37 is the system of example 36, wherein the fixed sensor includes a stationary camera, depth camera, infrared camera, or light detection and ranging (LiDAR) sensor.

Example 38 is the system of example 22, wherein the robot configured to determine the correspondence includes the robot configured to determine whether the robot is able to localize itself on the global map.

Example 39 is the system of example 22, wherein the quality metric includes a confidence metric for the map data of the mapped subarea.

Example 40 is the system of example 22, wherein the map manager is configured to update the global map in real-time when the map data of the mapped subarea is received at the map manager from the robot.

Example 41 is the system of example 22, wherein the map manager is configured to provide the global map as an updated global map to the robot.

Example 42 is the system of example 22, wherein the robot is configured to receive the global map from the map manager as an updated global map and to use the updated global map for navigation.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising a processor configured to:
determine a correspondence between a global map of an environment and a mapped subarea of the environment, wherein the mapped subarea is received from a robot within the environment;
determine a quality metric of map data of the mapped subarea with respect to the global map; and
update the global map with the map data of the mapped subarea based on the quality metric.

2. The device of claim 1, wherein the processor is configured to determine the quality metric based on a comparison of the map data of the mapped subarea to an second set of map data that at least partially overlaps with the mapped subarea, wherein the second set of map data is received from a second robot in the environment.

3. The device of claim 2, wherein the processor is configured to update, based on whether the map data of the mapped subarea satisfies a predefined criterion with respect to the second set of map data, the global map with the map data of the mapped subarea.

4. The device of claim 3, wherein the predefined criterion comprises an occupancy metric that characterizes occupied spaces in the mapped subarea and relates to occupancy information of the map data and of the second set of map data that at least partially overlaps with the mapped subarea.

5. The device of claim 3, wherein the predefined criterion comprises: an environmental characteristic of the map data with respect to the second set of map data; a floor reflection or a light condition of the mapped subarea; or an extent to which objects in the global map correspond to objects within the map data of the mapped subarea.

6. The device of claim 1, wherein the processor configured to update the global map comprises the processor configured to stitch together the map data of the mapped subarea with the global map along an edge of the mapped subarea with an edge of the global map.

7. The device of claim 1, wherein the processor configured to determine the correspondence comprises: the processor configured to identify occupied space in the map data of the mapped subarea that differs from the global map; or the processor configured to determine whether the mapped subarea is contained within the global map.

8. The device of claim 1, wherein the quality metric is based on a comparison of the map data of the mapped subarea to an second set of map data that at least partially overlaps with the mapped subarea, wherein the processor is configured to receive the second set of map data from a fixed sensor within the environment.

9. The device of claim 8, wherein the fixed sensor comprises a stationary camera, depth camera, infrared camera, or light detection and ranging (LiDAR) sensor.

10. The device of claim 1, wherein the processor configured to determine the correspondence comprises the processor configured to determine whether the robot is able to localize itself on the global map.

11. The device of claim 1, wherein the quality metric comprises a confidence metric for the map data of the mapped subarea.

12. The device of claim 1, wherein the robot is configured to update the global map in real-time when the map data of the mapped subarea is received from the robot.

13. The device of claim 1, wherein the processor is configured to transmit the updated global map to the robot.

14. The device of claim 1, wherein the processor is further configured to control the robot to use the updated global map for navigation.

15. A system for map regeneration of an environment, the system comprising:
a map manager configured to maintain a global map of the environment; and
a robot configured to determine a correspondence between a mapped subarea of the environment and a global map of the environment and, based on the correspondence, transmit map data of the mapped subarea to a map manager, wherein the map manager is configured to:
determine a quality metric of the map data of the mapped subarea with respect to the global map; and
update the global map with the map data of the mapped subarea based on the quality metric.

16. The system of claim 15, wherein the quality metric is based on a comparison of the map data to a second set of map data that at least partially overlaps with the mapped subarea received from a second robot in the environment.

17. The system of claim 16, wherein the map manager is configured to update, based on whether the map data of the mapped subarea satisfies a predefined criterion with respect to the second set of map data, the global map with the map data of the mapped subarea.

18. The system of claim 17, wherein the predefined criterion comprises an occupancy metric that characterizes occupied spaces in the mapped subarea and relates to occupancy information of the map data and of the second set of map data that at least partially overlaps with the mapped subarea.

19. A computer-readable medium comprising instructions that, when executed by one or more processors, cause the one or more processors to:
determine a correspondence between a global map of an environment and a mapped subarea of the environment, wherein the mapped subarea is received from a robot within the environment;
determine a quality metric of map data of the mapped subarea with respect to the global map; and
update the global map with the map data of the mapped subarea based on the quality metric.

20. The computer-readable medium of claim 19, wherein the instructions further cause the one or more processors to determine the quality metric based on a comparison of the map data of the mapped subarea to an second set of map data that at least partially overlaps with the mapped subarea, wherein the second set of map data is received from a second robot in the environment.
